(19) United States
(12) Patent Application Publication
(10) Pub. No.: US 2025/0284421 A1
(43) Pub. Date: Sep. 11, 2025

(54) THERMAL THROTTLING OF A MEMORY SYSTEM

(71) Applicant: Micron Technology, Inc., Boise, ID (US)

(72) Inventors: Nitul Gohain, Bangalore (IN); John E. Maroney, Irvine, CA (US)

(21) Appl. No.: 19/057,747

(22) Filed: Feb. 19, 2025

Related U.S. Application Data
(60) Provisional application No. 63/563,835, filed on Mar. 11, 2024.

(51) Int. Cl. G06F 3/06

(52) U.S. Cl. CPC G06F 3/0634; G06F 3/0616; G06F 3/0679

(57) ABSTRACT

Methods, systems, and devices for thermal throttling of a memory system are described. The method may include the memory system operating according to a first performance state and determining, while the memory system operates according to the first performance state, whether a temperature metric of the memory system satisfies a first threshold corresponding to a second performance state. Further, the memory system may select, based on the temperature metric satisfying the first threshold, the second performance state from a set of three or more performance states and operate the memory system according to the second performance state based on selecting the second performance state.

### CROSS REFERENCE

The present Application for Patent claims priority to U.S. Patent Application No. 63/563,835 by Gohain et al., entitled “THERMAL THROTTLING OF A MEMORY SYSTEM,” filed Mar. 11, 2024, which is assigned to the assignee hereof, and which is expressly incorporated by reference in its entirety herein.

### TECHNICAL FIELD

The following relates to one or more systems for memory, including thermal throttling of a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports thermal throttling of a memory system in accordance with examples as disclosed herein.

FIGS. 2A and 2B show examples of flow diagrams that support thermal throttling of a memory system in accordance with examples as disclosed herein.

FIG. 3 shows an example of a flow diagram that supports thermal throttling of a memory system in accordance with examples as disclosed herein.

FIG. 4 shows a block diagram of a memory system that supports thermal throttling of a memory system in accordance with examples as disclosed herein.

FIG. 5 shows a flowchart illustrating a method or methods that support thermal throttling of a memory system in accordance with examples as disclosed herein.

### DETAILED DESCRIPTION

In some examples, components of a memory system may produce heat which may permanently damage the components. To mitigate such damage, the memory system may include one or more temperature sensors that may be configured to monitor a temperature of one or more of the components of the memory system. If the memory system determines that a respective temperature of a component is too high (e.g., above a threshold), the memory system may perform one or more actions. For example, the memory system may throttle a performance of the memory system (e.g., decrease a drive speed of the memory system) based on or in response to determining that the temperature of the component is too high. Further, the memory system may dynamically increase or decrease the performance of the memory system based on the temperature (e.g., the magnitude of the temperature). For example, the memory system may compare the temperature to a first threshold (e.g., management temperature (MT) 1) and a second threshold (e.g., MT2) that is greater than the first threshold. If the memory system determines that the temperature exceeds or meets the first threshold, the memory system may operate at a first performance level (e.g., 70 percent performance). Alternatively, if the memory system determines that the temperature exceeds or meets the second threshold, the memory system may operate at another performance level (e.g., 50 percent performance). That is, the memory system may include two levels of performance throttling.

However, in some scenarios, it may be beneficial for the memory system to include more than two levels of performance throttling. For example, in the automotive space, the memory system may experience a wide range of operating temperatures. In such scenarios, if the memory system operates with only two levels of performance throttling, the memory system may exhibit sharp increases and decreases in performance and additionally, the two levels of the performance throttling may not be applicable to all the temperatures experienced by the memory system. Therefore, to ensure smooth performance of the memory system, the memory system may support more than two levels of performance throttling.

As described herein, the memory system may support three or more levels of performance throttling and more sophisticated performance throttling procedures. After monitoring a respective temperature of a component, the memory system may compare the temperature to a first threshold (e.g., MT1), a second threshold (e.g., MT2), and a third threshold (e.g., MT3). The third threshold may be different than (e.g., greater than) the second threshold and the second threshold may be different than (e.g., greater than) the first threshold. If the memory system determines that the temperature exceeds or meets the first threshold, the memory system may operate at a first performance level (e.g., 70 percent performance). Alternatively, if the memory system determines that the temperature exceeds or meets the second threshold, the memory system may operate at a second performance level (e.g., 50 percent performance). Further, if the memory system determines that the temperature exceeds or meets the third threshold, the memory system may operate at a third performance level (e.g., 25 percent performance). That is, the memory system may include at least three levels of performance throttling which may ensure smooth performance of the memory system in scenarios where the memory system experiences a wide range of operating temperatures, such as in automotive applications.

In addition to applicability in memory systems as described herein, techniques for thermal throttling for a memory system may be generally implemented to improve the sustainability of various electronic devices and systems. As the use of electronic devices has become even more widespread, the quantity of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by extending the life of electronic devices and thereby reducing electronic waste, among other benefits.

Features of the disclosure are illustrated and described in the context of systems, devices, and circuits. Features of the disclosure are further illustrated and described in the context of flow diagrams and flowcharts.

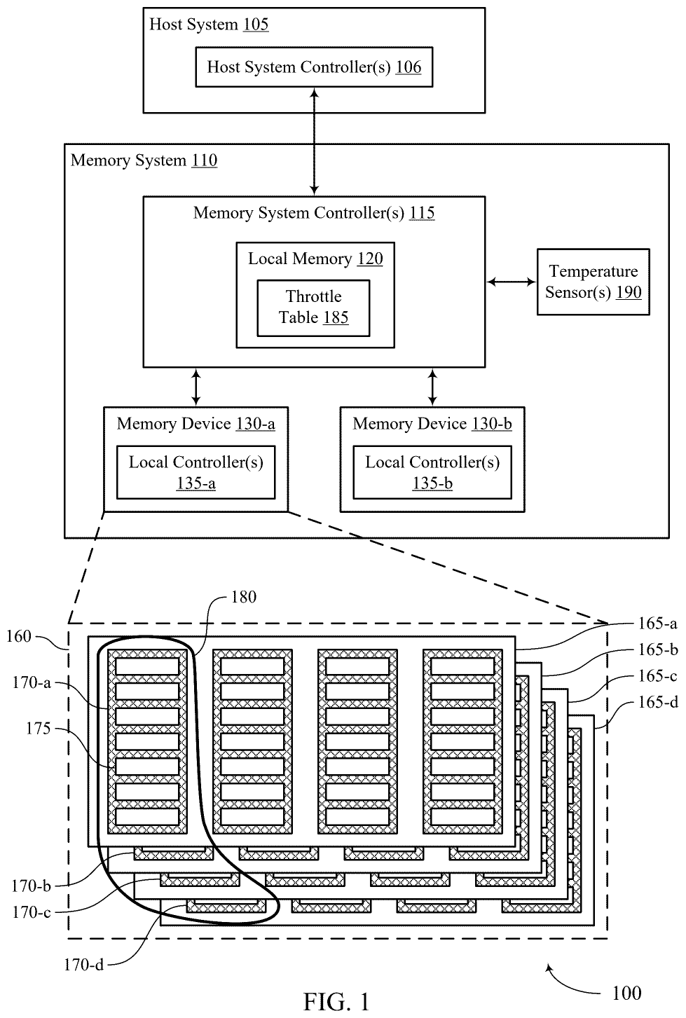

FIG. 1 shows an example of a system 100 that supports thermal throttling of a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), one or more memory controllers (e.g., NVDIMM controller), and one or more storage protocol controllers (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include one or more memory system controllers 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including one or more memory system controllers 115, in some cases, a memory system 110 may not include one or more memory system controllers 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

The system 100 may include any quantity of non-transitory computer readable media that support thermal throttling of a memory system. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

As described herein, the memory system 110 may support more than two levels of performance throttling. In some examples, the memory system 110 may operate according to a first performance state. Further, the memory system may monitor a temperature of the memory system (e.g., a temperature of the memory system controller 115 or a memory device 130) via temperature sensors 190 and compare the temperature to one or more thresholds.

In some examples, each of the one or more thresholds may correspond to a respective performance state. As one example, the one or more thresholds may include a first threshold corresponding to the first performance state, a second threshold corresponding to a second performance state, and a third threshold corresponding to a third performance state. In some examples, the memory system 110 may store a mapping between the one or more thresholds and the respective performance states in the local memory 120 in the form of a throttle table 185.

If the memory system 110 determines that the temperature satisfies (e.g., is greater than or equal to) the second threshold of the one or more threshold, the memory system 110 may select the second performance state from a set of performance states that include at least the first performance state, the second performance state and the third performance state. Upon selecting the second performance state the memory system 110 may operate according to the second performance state. That is, the memory system 110 may update from the first performance to the second performance state. In some examples, updating from the first performance state to the second performance state may include updating (e.g., increasing or decrease) a percentage by which the memory system 110 throttles the performance of the memory system 110. Using the method as described herein may allow the memory system to operate smoothly in situation where the memory system 110 experience a wide operating temperature range (e.g., automotive).

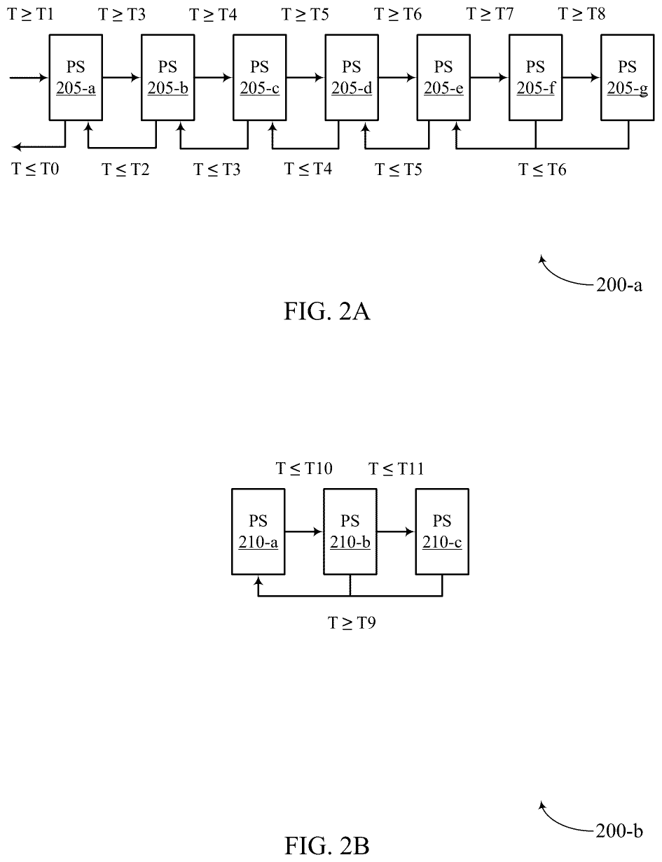

FIGS. 2A and 2B show examples of a flow diagram (e.g., a flow diagram 200-a and a flow diagram 200-b) that supports thermal throttling of a memory system in accordance with examples as disclosed herein. In some examples, the flow diagrams 200-a and/or 200-b may be implemented by aspects of the system 100. For example, the flow diagram 200-a and/or 200-b may be implemented by one or more components of a memory system 110 (e.g., one or more memory system controllers 115) as described with reference to FIG. 1.

In some examples, a memory system may monitor a temperature of one or more components of the memory system. For example, the memory system may monitor a temperature of one or more memory devices of the memory system or a controller of the memory system. Additionally, the memory system may a calculate a composite temperature based on one or both of the controller temperature or the memory device temperatures.

To calculate the composite temperature, the memory system may first obtain the controller temperature and subtract a value (e.g., 2.5 degrees Celsius) from the controller temperature to get a first temperature (e.g., Tjcon_off). After this, the memory system may compare the first temperature to a composite temperature threshold (e.g., 20 degrees Celsius). If the first temperature is greater than the composite temperature threshold, the composite temperature may be equal to a maximum temperature selected from the first temperature and the memory device temperatures. If the first temperature is less than the composite temperature threshold, the composite temperature may be equal to a minimum temperature selected from the first temperature and the memory device temperatures.

Aperiodically or periodically (e.g., every 1 second, 500 milliseconds, or 150 milliseconds), the memory system may obtain the temperature (e.g., the composite temperature, the controller temperature, or the memory device temperature) and compare the temperature to a set of thresholds. Each threshold of the set of thresholds may correspond to a performance state of a set of performance states and each performance state may specify a throttling scheme for the memory system. A throttling scheme may indicate one or more actions that the memory system may perform to decrease a performance of the memory system or indicate a percentage by which the memory system may decrease the performance of the memory system.

If the memory system determines that the temperature satisfies a threshold corresponding to a performance state of the set of performance states, the memory system may perform the one or more actions indicated by the throttling scheme corresponding to the performance state. In some examples, the memory system may store the set of thresholds and the corresponding set of performance states in a memory of the memory system. For example, the memory system may store the set of thresholds and the corresponding set of performance states in a local memory of a controller of the memory system (e.g., in the form of a table).

The flow diagram 200-a may be an example of a hot flow and may illustrate a set of performance states 205 that the memory system may enter when the memory system experiences high temperatures (e.g., temperatures above or equal to 98 degrees Celsius). As shown in FIG. 2A, the set of performance states 205 may include a performance state 205-a (e.g., a pre-throttling state), a performance state 205-b (e.g., MT1), a performance state 205-c (e.g., MT2), a performance state 205-d (e.g., MT3), a performance state 205-e (e.g., an extreme state), a performance state 205-f (e.g., an abort state), and a performance state 205-g (e.g., a shutdown state).

In some examples, each performance state 205 of the set of performance states 205 may be associated with at least an entrance threshold and an exit threshold. In order for the memory system to enter a performance state 205, the temperature may meet or exceed an entrance threshold of the performance state 205 and may be less than an entrance threshold of a different performance state 205. To exit the performance state 205, the temperature may meet or be below an exit threshold of the performance state 205. In some examples, a temperature of the exit threshold of the performance state 205 may be lower than a temperature of an entrance threshold of the performance state 205.

In the example of FIG. 2A, the performance state 205-a, the performance state 205-b, the performance state 205-c, the performance state 205-d, the performance state 205-e, the performance state 205-f, and the performance state 205-g may correspond to an entrance threshold of T1, T3, T4, T5, T6, T7, and T8, respectively. Table 1 illustrates example of composite temperatures for T1, T3, T4, T5, T6, T7, and T8 in Celsius. According to Table 1, the entrance thresholds may increase from the performance state 205-a to the performance state 205-g. For example, as shown in Table 1, T1, T3, T4, T5, T6, T7, and T8 may be equal to 98 degrees Celsius, 111 degrees Celsius, 113 degrees Celsius, 116 degrees Celsius, 118 degrees Celsius, 121 degrees Celsius, and 123 degrees Celsius, respectively.

Further, as shown in FIG. 2A, the performance state 205-a, the performance state 205-b, the performance state 205-c, the performance state 205-d, and the performance state 205-e may correspond to an exit threshold of T0, T2, T3, T4, and T5, respectively, and the performance state 205-f, and the performance state 205-g may correspond to an exit threshold of T6. Table 1 further illustrates examples of composite temperatures for TO, T2, T3, T4, and T5. According to Table 1, the entrance threshold may increase from the performance state 205-a to the performance state 205-g. For example, as shown in Table 1, TO, T2, T3, T4, T5, and T6 may be equal to 96 degrees Celsius, 109 degrees Celsius, 111 degrees Celsius, 113 degrees Celsius, 116 degrees Celsius, and 118 degrees Celsius, respectively.

TABLE 1

| PS | 205-a | 205-b | 205-c | 205-d | 205-e | 205-f | 205-g |
|---|---|---|---|---|---|---|---|
| Hot Temp. | ≥98° C. | ≥111° C. | ≥113° C. | ≥116° C. | ≥118° C. | ≥121° C. | ≥123° C. |
| (Entry) | | | | | | | |
| Hot Temp. | ≤96° C. | ≤109° C. | ≤111° C. | ≤113° C. | ≤116° C. | ≤118° C. | ≤118° C. |
| (Exit) | | | | | | | |

The memory device may determine the temperature (e.g., the composite temperature) and compare the temperature to the thresholds (e.g., TO through T8). If the temperature satisfies at least one of the thresholds, the memory system may update a performance state 205 of the memory system. In one example, the memory system may initially operate according to a performance state 205-c and determine, while operating according to the performance state 205-c, that the temperature is equal to 117 degrees Celsius. In such example, the memory system may update the performance state 205 of the memory system from the performance state 205-c to the performance state 205-d because the temperature exceeds the entrance temperature of the performance state 205-d.

Further, while operating according to the performance state 205-d, the memory device may determine that the temperature is equal to 113 degrees Celsius. In such case, the memory system may update the performance state from the performance state 205-d to the performance state 205-c because the temperature is equal to the exit temperature of the performance state 205-d and in addition, the temperature is equal to the entrance temperature of the performance state 205-c.

Although the above example describes the memory system switching between the performance state 205-c to performance state 205-d, it is understood that the memory system may switch between any of the performance states 205. For example, the memory system may update the performance state 205 from the performance state 205-a to the performance state 205-e. Additionally, the memory system may update the performance state 205 from the performance state 205-d to the performance state 205-b.

As described above, each performance state 205 may be associated with a different throttling scheme. For example, the performance state 205-a may represent a pre-throttling state in which the memory system may not throttle the performance of the memory system. However, upon entering the performance state 205-a, the memory system may update (or increase) a rate at which the memory system samples the temperature. For example, once the memory system enters the performance state 205-a, the memory system may update the temperature sampling rate from 1 second to 500 milliseconds.

Conversely, upon entering the performance state 205-b, the memory system may throttle a performance of the memory system by a first percentage (e.g., 30 percent) using one or more throttling techniques (e.g., command throttling or clock throttling). Additionally, upon entering the performance state 205-b, the memory system may update (or increase) a rate at which the memory system samples the temperature. For example, once the memory system enters the performance state 205-b, the memory system may update the temperature sampling rate from 1 second or 500 milliseconds to 150 milliseconds.

Upon entering the performance state 205-c, the memory system may throttle the performance of the memory system by a second percentage (e.g., 50 percent) using the one or more throttling techniques. Whereas, in the performance state 205-d, the memory system may throttle the performance of the memory system by a third percentage (e.g., 75 percent) using the one or more throttling techniques. On the other hand, the performance state 205-e may represent an extreme state that may prevent the memory system from entering a shutdown state. Upon entering the extreme state, the memory system may throttle a performance of the memory system by a fourth percentage (e.g., 87.5 percent) using the one or more throttling techniques. Further, in the extreme state, the memory system may apply a delay to the application processing unit (APU) or central processing unit (CPU) and perform peak power management (PPM).

The performance state 205-f may represent a thermal abort state. While in the thermal abort state, the memory system may flush application data from one or more memory devices of the memory system, stop issuing access commands to the one or more memory devices, or abort active access commands. In some examples, during thermal abort, the memory system may continue to perform some commands such as administration commands not associated with media access (e.g., identify command, get log command, or set/get feature command), commands associated with flushing the application data, or commands to test thermal throttling. Lastly, the performance state 205-g may represent a shutdown state. While in the shutdown state, the memory system may appear to be off and the memory system may reduce power consumption to a lowest level (e.g., power state 4). For example, the memory system may perform techniques similar to thermal abort, but with the additional of halting the performance of background jobs.

The flow diagram 200-b may be an example of cold flow and may illustrate a set of performance states 210 that the memory system may enter when a component of the memory system reaches low temperatures (e.g., temperatures below −40 degrees). As shown in FIG. 2B, the set of performance states 210 may include a performance state 210-a (e.g., pre-throttling state), a performance state 210-b (e.g., an abort state), and a performance state 210-c (e.g., a shutdown state).

In some examples, the performance state 210-b and the performance state 210-c of the set of performance states 210 may be associated with an entrance threshold and an exit threshold. In order for the memory system to enter a performance state 210 (e.g., the performance state 210-b and the performance state 210-c), the temperature may be less than or equal to an entrance threshold of the performance state 210 and may be greater than an entrance threshold of a different performance state 210. To exit the performance state 210, the temperature may be equal to or greater than an exit threshold of the performance state 210. In some examples, a temperature of the exit threshold of a performance state 210 may be greater than a temperature of an entrance threshold of the performance state 210.

In the example of FIG. 2B, the performance state 210-b and the performance state 210-c may correspond to an entrance threshold of T10 and T11, respectively. Table 2 illustrates example composite temperatures for T10 and T11. According to Table 2, the entrance thresholds may decrease from the performance state 210-b to the performance state 210-c. For example, as shown in Table 1, T10 and T11 may be equal to −42 degrees Celsius and −45 degrees Celsius, respectively. Further, as shown in FIG. 2B, the performance state 210-b and the performance state 210-c may correspond to an exit threshold of T9. Table 2 further illustrates an example composite temperature for T9. According to Table 1, T9 may be equal to −40 degrees Celsius.

TABLE 2

| PS | 210-b | 210-c |
|---|---|---|
| Cold Temp. (Entry) | ≤−42° C. | ≤−45° C. |
| Cold Temp. (Exit) | ≥−40° C. | ≥−40° C. |

The memory device may determine the temperature (e.g., the composite temperature) and compare the temperature to the thresholds (e.g., T9 through T11). If the temperature satisfies at least one of the thresholds, the memory system may update a performance state 210 of the memory system. In one example, the memory system may initially operate according to the performance state 210-a and determine, while operating according to the performance state 210-a, that the temperature is equal to −45 degrees Celsius. In such example, the memory system may update the performance state 210 of the memory system from the performance state 210-a to the performance state 210-c because the temperature is equal to the entrance temperature of the performance state 210-c.

Further, while operating according to the performance state 210-c, the memory device may determine that the temperature is equal to −39 degrees Celsius. In such case, the memory system may update the performance state 210 from the performance state 210-c to the performance state 205-a because the temperature is equal to the exit temperature of the performance state 210-c and in addition, the temperature is greater than the entrance temperature of the performance state 210-b.

As described above, each performance state 210 may be associated with a different throttling scheme. For example, the performance state 210-a may represent a pre-throttling state in which the memory system may not throttle the performance of the memory system. Conversely, the performance state 210-b may represent a thermal abort state. While in the thermal abort state, the memory system may flush application data from one or more memory devices of the memory system, stop issuing access commands to the one or more memory devices, or abort active access commands. In some examples, during thermal abort, the memory system may continue to perform some commands such as administration commands not associated with media access (e.g., identify command, get log command, or set/get feature command), commands associated with flushing the application data, or commands to test thermal throttling.

Lastly, the performance state 210-c may represent a shutdown state. While in the shutdown state, the memory system may appear to be off and the memory system may reduce the power consumption to the lowest level (e.g., power state 4). For example, the memory system may perform techniques similar to thermal abort, but with the addition of halting the performance of background jobs. Using the techniques as described herein, a memory system may support more than two performance throttling state which may allow the memory system to operate smooth over a wide range of temperatures.

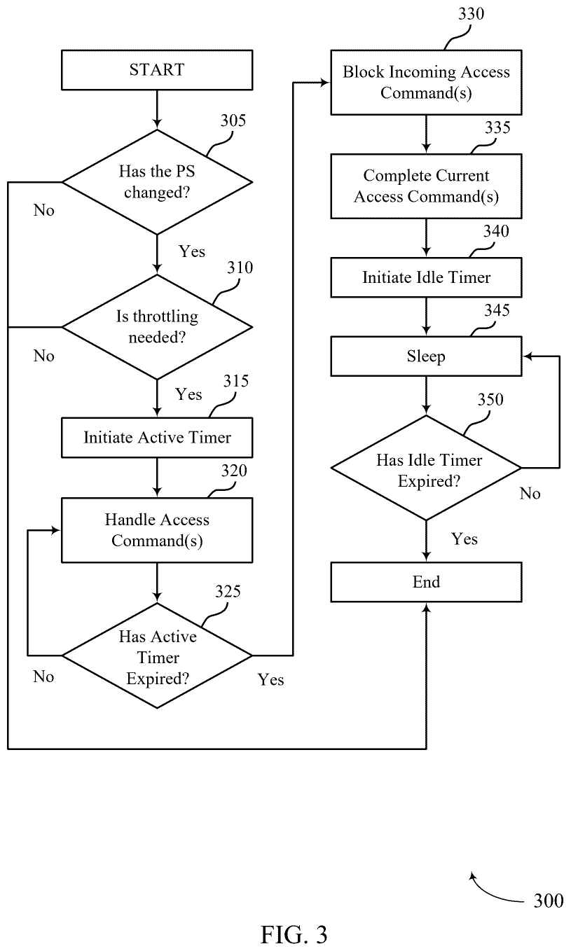

FIG. 3 shows an example of a flow diagram 300 that supports thermal throttling of a memory system in accordance with examples as disclosed herein. In some examples, the flow diagrams 300 may be implemented by aspects of the system 100. For example, the flow diagram 300 may be implemented by one or more components of a memory system 110 (e.g., a memory system controller 115) as described with reference to FIG. 1.

At 305, the memory system may determine whether a performance state of the memory system has changed. As described with reference to FIG. 2, the memory system may monitor a temperature of the memory system (e.g., a temperature of a memory device of the memory system or a temperature of a controller of the memory system) and compare the temperature to a set of thresholds that each correspond to a respective performance state. In some examples, the memory system may perform the process indicated by the flow diagram 300 according to a sample rate of the temperature (e.g., every 1 second, 500 milliseconds, or 150 milliseconds).

In one example, the memory system may operate according to a first performance state and determine that the temperature satisfies a threshold corresponding to a second performance state. In such example, the memory system may update the performance state from the first performance state to the second performance state, determine that the performance state has changed, and proceed to 310. Alternatively, the memory system may operate according to the first performance state and determine that the temperature does not satisfy a threshold of the set of thresholds. In such example, the memory system may continue operation according to the first performance state, determine that the performance state has not changed, and the process indicated in the flow diagram 300 may end.

At 310, the memory system may determine if throttling is needed. In some examples, the memory system may determine whether throttling is needed based on the second performance state. For example, if the second performance state includes one of an MT1 state, an MT2 state, an MT3 state, an extreme state, an abort state, or a shutdown state, the memory system may implement command throttling and proceed to 315. However, if the second performance state includes the pre-throttling state, the memory system may not implement command throttling and the process indicated in the flow diagram 300 may end.

At 315, the memory system may perform command throttling and initiate an active timer. In some examples, a first duration of the active timer may depend on the second performance state. That is, the first duration associated with the active timer may be different for different performance states. For example, the first duration for the active timer for the MT3 state may be less than the first duration for the active timer for the MT1 state.

At 320, the memory system may handle access commands (e.g., read commands and write commands) during the duration of the active timer. That is, the memory system may receive access commands from the host system and perform the access command on the one or more memory devices of the memory system.

At 325, the memory system may determine whether the active timer has expired. If the memory system determines the active timer expires, the memory system may proceed to 330. Alternatively, the memory system may determine that the active timer does not expire and proceed to 320.

At 330, the memory system may block incoming access command from a host system and at 335, the memory system may complete current access commands. Current commands may refer to commands in a command queue of the memory system.

At 340, the memory system may initiate an idle timer. In some examples, a second duration of the idle timer may depend on the second performance state. That is, the second duration associated with the idle timer may be different for different performance states. For example, the second duration for the idle timer for the MT3 state may be greater than the second duration for the idle timer for the MT1 state.

At 345, the memory system may enter a sleep mode. During the sleep mode, a CPU of the memory system may be inactive (e.g., powered off) and the memory system may not perform access commands.

At 350, the memory system may determine whether the idle timer has expired. If the memory system determines the idle timer expired, the process indicated in the flow diagram 300 may end. Alternatively, the memory system may determine that the idle timer does not expire and proceed to 345.

Additionally or alternatively, the memory system may perform clock throttling. For example, if the memory system determines that throttling is needed at 310, the memory system may perform clock throttling. To perform clock throttling, the memory system may update a clock speed of a clock (e.g., CPU clock, LDPC clock, or memory device clock) of the memory system. For example, the memory system may decrease the clock speed in response to determining that throttling is needed. In some examples, a value by which the memory system adjusts the clock speed may be based on the second performance state. For example, the value by which the memory system reduces the clock speed for MT3 may be greater than when the memory system is in the MT1 state.

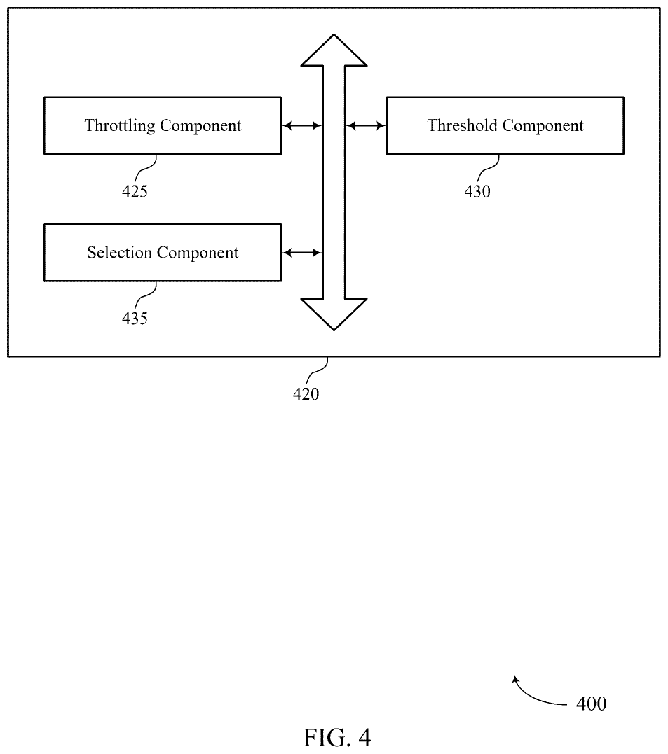

FIG. 4 shows a block diagram 400 of a memory system 420 that supports thermal throttling of a memory system in accordance with examples as disclosed herein. The memory system 420 may be an example of aspects of a memory system as described with reference to FIGS. 1 through 3. The memory system 420, or various components thereof, may be an example of means for performing various aspects of thermal throttling of a memory system as described herein. For example, the memory system 420 may include a throttling component 425, a threshold component 430, a selection component 435, or any combination thereof. Each of these components, or components of subcomponents thereof (e.g., one or more processors, one or more memories), may communicate, directly or indirectly, with one another (e.g., via one or more buses).

The throttling component 425 may be configured as or otherwise support a means for operating the memory system according to a first performance state. The threshold component 430 may be configured as or otherwise support a means for determining, while the memory system operates according to the first performance state, whether a temperature metric of the memory system satisfies a first threshold corresponding to a second performance state. The selection component 435 may be configured as or otherwise support a means for selecting, based at least in part on determining that the temperature metric satisfies the first threshold, the second performance state from a plurality of performance states including at least the first performance state, the second performance state, and a third performance state. In some examples, the throttling component 425 may be configured as or otherwise support a means for operating the memory system according to the second performance state based at least in part on selecting the second performance state.

In some examples, the threshold component 430 may be configured as or otherwise support a means for determining, while the memory system operates according to the second performance state, whether the temperature metric of the memory system satisfies a second threshold corresponding to the third performance state. In some examples, the selection component 435 may be configured as or otherwise support a means for selecting, based at least in part on determining that the temperature metric satisfies the second threshold, the third performance state from the plurality of performance states. In some examples, the throttling component 425 may be configured as or otherwise support a means for operating the memory system according to the third performance state based at least in part on selecting the third performance state.

In some examples, the threshold component 430 may be configured as or otherwise support a means for determining, while the memory system operates according to the second performance state, whether the temperature metric of the memory system satisfies a second threshold corresponding to the second performance state. In some examples, the selection component 435 may be configured as or otherwise support a means for selecting, based at least in part on determining that the temperature metric satisfies the second threshold, the first performance state from the plurality of performance states. In some examples, the throttling component 425 may be configured as or otherwise support a means for operating the memory system according to the first performance state based at least in part on selecting the third performance state. In some examples, the second threshold is lower than the first threshold.

In some examples, to support operating the memory system according to the second performance state, the throttling component 425 may be configured as or otherwise support a means for initiating a first timer corresponding to the second performance state. In some examples, to support operating the memory system according to the second performance state, the throttling component 425 may be configured as or otherwise support a means for performing a first set of access operations during a duration of the first timer. In some examples, to support operating the memory system according to the second performance state, the throttling component 425 may be configured as or otherwise support a means for initiating a second timer corresponding to the second performance state based at least in part on an expiration of the first timer. In some examples, to support operating the memory system according to the second performance state, the throttling component 425 may be configured as or otherwise support a means for refraining from performing a second set of access operation during a duration of the second timer.

In some examples, to support operating the memory system according to the second performance state, the throttling component 425 may be configured as or otherwise support a means for updating one or more parameters corresponding to a system clock of the memory system. In some examples, to support operating the memory system according to the second performance state, the throttling component 425 may be configured as or otherwise support a means for performing one or more actions that include discarding application data, refraining from issuing commands to one or more memory devices of the memory system, refraining from performing access commands at the one or more memory devices, or any combination thereof.

In some examples, each performance state of the plurality of performance states corresponds to an operating speed of the memory system that is lower than a threshold operating speed of the memory system. In some examples, the first performance state indicates to throttle a performance of the memory system by at least 30 percent, the second performance state indicates to throttle the performance of the memory system by at least 50 percent, and the third performance state indicates to throttle the performance of the memory system by at least 75 percent.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

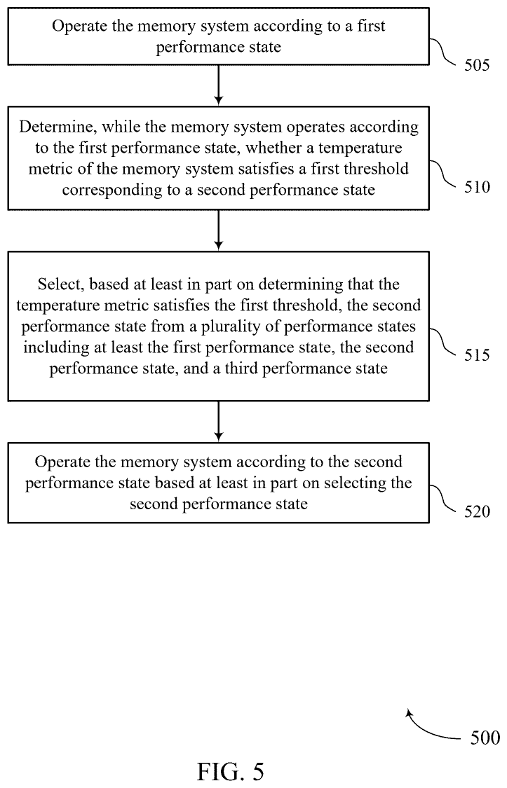

FIG. 5 shows a flowchart illustrating a method 500 that supports thermal throttling of a memory system in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include operating the memory system according to a first performance state. In some examples, aspects of the operations of 505 may be performed by a throttling component 425 as described with reference to FIG. 4.

At 510, the method may include determining, while the memory system operates according to the first performance state, whether a temperature metric of the memory system satisfies a first threshold corresponding to a second performance state. In some examples, aspects of the operations of 510 may be performed by a threshold component 430 as described with reference to FIG. 4.

At 515, the method may include selecting, based at least in part on determining that the temperature metric satisfies the first threshold, the second performance state from a plurality of performance states including at least the first performance state, the second performance state, and a third performance state. In some examples, aspects of the operations of 515 may be performed by a selection component 435 as described with reference to FIG. 4.

At 520, the method may include operating the memory system according to the second performance state based at least in part on selecting the second performance state. In some examples, aspects of the operations of 520 may be performed by a throttling component 425 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for operating the memory system according to a first performance state; determining, while the memory system operates according to the first performance state, whether a temperature metric of the memory system satisfies a first threshold corresponding to a second performance state; selecting, based at least in part on determining that the temperature metric satisfies the first threshold, the second performance state from a plurality of performance states including at least the first performance state, the second performance state, and a third performance state; and operating the memory system according to the second performance state based at least in part on selecting the second performance state.

Aspect 2: The method, apparatus, or non-transitory computer-readable medium of aspect 1, further including operations, features, circuitry, logic, means, or instructions, or any combination thereof for determining, while the memory system operates according to the second performance state, whether the temperature metric of the memory system satisfies a second threshold corresponding to the third performance state; selecting, based at least in part on determining that the temperature metric satisfies the second threshold, the third performance state from the plurality of performance states; and operating the memory system according to the third performance state based at least in part on selecting the third performance state.

Aspect 3: The method, apparatus, or non-transitory computer-readable medium of any of aspects 1 through 2, further including operations, features, circuitry, logic, means, or instructions, or any combination thereof for determining, while the memory system operates according to the second performance state, whether the temperature metric of the memory system satisfies a second threshold corresponding to the second performance state; selecting, based at least in part on determining that the temperature metric satisfies the second threshold, the first performance state from the plurality of performance states; and operating the memory system according to the first performance state based at least in part on selecting the third performance state.

Aspect 4: The method, apparatus, or non-transitory computer-readable medium of aspect 3, where the second threshold is lower than the first threshold.

Aspect 5: The method, apparatus, or non-transitory computer-readable medium of any of aspects 1 through 4, where operating the memory system according to the second performance state includes operations, features, circuitry, logic, means, or instructions, or any combination thereof for initiating a first timer corresponding to the second performance state; performing a first set of access operations during a duration of the first timer; initiating a second timer corresponding to the second performance state based at least in part on an expiration of the first timer; and refraining from performing a second set of access operation during a duration of the second timer.

Aspect 6: The method, apparatus, or non-transitory computer-readable medium of any of aspects 1 through 5, where operating the memory system according to the second performance state includes operations, features, circuitry, logic, means, or instructions, or any combination thereof for updating one or more parameters corresponding to a system clock of the memory system.

Aspect 7: The method, apparatus, or non-transitory computer-readable medium of any of aspects 1 through 6, where operating the memory system according to the second performance state includes operations, features, circuitry, logic, means, or instructions, or any combination thereof for performing one or more actions that include discarding application data, refraining from issuing commands to one or more memory devices of the memory system, refraining from performing access commands at the one or more memory devices, or any combination thereof.

Aspect 8: The method, apparatus, or non-transitory computer-readable medium of any of aspects 1 through 7, where each performance state of the plurality of performance states corresponds to an operating speed of the memory system that is lower than a threshold operating speed of the memory system.

Aspect 9: The method, apparatus, or non-transitory computer-readable medium of any of aspects 1 through 8, where the first performance state indicates to throttle a performance of the memory system by at least 30 percent, the second performance state indicates to throttle the performance of the memory system by at least 50 percent, and the third performance state indicates to throttle the performance of the memory system by at least 75 percent.

It should be noted that the described techniques include possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 10: A memory system, including: one or more memory devices configured to store a plurality of performance states, the plurality of performance states including a first performance state, a second performance state, and a third performance state, each performance state of the plurality of performance states indicating to throttle a performance of the memory system by a respective amount; and one or more controllers coupled with the one or more memory devices and configured to cause the memory system to: monitor a temperature metric of the memory system at a first time; determine, based at least in part on monitoring the temperature metric at the first time, whether the temperature metric satisfies a first threshold corresponding to the first performance state, a second threshold corresponding to the second performance state, or a third threshold corresponding to the third performance state; and throttle, based at least in part on determining that the temperature metric satisfies the first threshold, the performance of the memory system by the respective amount indicated by the first performance state.

Aspect 11: The memory system of aspect 10, where the one or more controllers are further configured to cause the memory system to: monitor the temperature metric of the memory system at a second time; determine, based at least in part on monitoring the temperature metric at the second time, whether the temperature metric satisfies the first threshold, the second threshold, or the third threshold; and throttle, based at least in part on determining that the temperature metric satisfies the second threshold, the performance of the memory system by the respective amount indicated by the second performance state.

Aspect 12: The memory system of aspect 11, where the one or more controllers are further configured to cause the memory system to: monitor the temperature metric of the memory system at a third time; determine, based at least in part on monitoring the temperature metric at the third time, whether the temperature metric satisfies the first threshold, the second threshold, or the third threshold; and throttle, based at least in part on determining that the temperature metric satisfies the third threshold, the performance of the memory system by the respective amount indicated by the third performance state.

Aspect 13: The memory system of any of aspects 11 through 12, where the one or more controllers are further configured to cause the memory system to: monitor the temperature metric of the memory system at a third time; determine, based at least in part on monitoring the temperature metric at the third time, whether the temperature metric satisfies a fourth threshold corresponding to the second performance state; and throttle, based at least in part on determining that the temperature metric satisfies the fourth threshold, the performance of the memory system by the respective amount indicated by the first performance state.

Aspect 14: The memory system of aspect 13, where the fourth threshold is lower than the second threshold.

Aspect 15: The memory system of any of aspects 10 through 14, where, to throttle the performance of the memory system, the one or more controllers are configured to: initiate a first timer corresponding to the first performance state; perform a first set of access operations during a duration of the first timer; initiate a second timer corresponding to the first performance state based at least in part on an expiration of the first timer; and refrain from performing a second set of access operation during a duration of the second timer.

Aspect 16: The memory system of any of aspects 10 through 15, where, to throttle the performance of the memory system, the one or more controllers are configured to: update one or more parameters corresponding to a system clock of the memory system.

Aspect 17: The memory system of any of aspects 10 through 16, where, to throttle the performance of the memory system, the one or more controllers are configured to: perform one or more actions that include discarding application data, refraining from issuing commands to the one or more memory devices, refraining from performing access commands at the one or more memory devices, or any combination thereof.

Aspect 18: The memory system of any of aspects 10 through 17, where the first performance state indicates to throttle the performance of the memory system by at least 30 percent, the second performance state indicates to throttle the performance of the memory system by at least 50 percent, and the third performance state indicates to throttle the performance of the memory system by at least 75 percent.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method by a memory system, comprising:
operating the memory system according to a first performance state;
determining, while the memory system operates according to the first performance state, whether a temperature metric of the memory system satisfies a first threshold corresponding to a second performance state;
selecting, based at least in part on determining that the temperature metric satisfies the first threshold, the second performance state from a plurality of performance states comprising at least the first performance state, the second performance state, and a third performance state; and
operating the memory system according to the second performance state based at least in part on selecting the second performance state.

2. The method of claim 1, further comprising:
determining, while the memory system operates according to the second performance state, whether the temperature metric of the memory system satisfies a second threshold corresponding to the third performance state;
selecting, based at least in part on determining that the temperature metric satisfies the second threshold, the third performance state from the plurality of performance states; and
operating the memory system according to the third performance state based at least in part on selecting the third performance state.

3. The method of claim 1, further comprising:
determining, while the memory system operates according to the second performance state, whether the temperature metric of the memory system satisfies a second threshold corresponding to the second performance state;
selecting, based at least in part on determining that the temperature metric satisfies the second threshold, the first performance state from the plurality of performance states; and
operating the memory system according to the first performance state based at least in part on selecting the third performance state.

4. The method of claim 3, wherein the second threshold is lower than the first threshold.

5. The method of claim 1, wherein operating the memory system according to the second performance state comprises:
initiating a first timer corresponding to the second performance state;
performing a first set of access operations during a duration of the first timer;
initiating a second timer corresponding to the second performance state based at least in part on an expiration of the first timer; and
refraining from performing a second set of access operation during a duration of the second timer.

6. The method of claim 1, wherein operating the memory system according to the second performance state comprises:
updating one or more parameters corresponding to a system clock of the memory system.

7. The method of claim 1, wherein operating the memory system according to the second performance state comprises:
performing one or more actions that comprise discarding application data, refraining from issuing commands to one or more memory devices of the memory system, refraining from performing access commands at the one or more memory devices, or any combination thereof.

8. The method of claim 1, wherein each performance state of the plurality of performance states corresponds to an operating speed of the memory system that is lower than a threshold operating speed of the memory system.

9. The method of claim 1, wherein the first performance state indicates to throttle a performance of the memory system by at least 30 percent, the second performance state indicates to throttle the performance of the memory system by at least 50 percent, and the third performance state indicates to throttle the performance of the memory system by at least 75 percent.

10. A memory system, comprising:
one or more memory devices configured to store a plurality of performance states, the plurality of performance states comprising a first performance state, a second performance state, and a third performance state, each performance state of the plurality of performance states indicating to throttle a performance of the memory system by a respective amount; and
one or more controllers coupled with the one or more memory devices and configured to cause the memory system to:
monitor a temperature metric of the memory system at a first time;
determine, based at least in part on monitoring the temperature metric at the first time, whether the temperature metric satisfies a first threshold corresponding to the first performance state, a second threshold corresponding to the second performance state, or a third threshold corresponding to the third performance state; and
throttle, based at least in part on determining that the temperature metric satisfies the first threshold, the performance of the memory system by the respective amount indicated by the first performance state.

11. The memory system of claim 10, wherein the one or more controllers are further configured to cause the memory system to:
monitor the temperature metric of the memory system at a second time;
determine, based at least in part on monitoring the temperature metric at the second time, whether the temperature metric satisfies the first threshold, the second threshold, or the third threshold; and
throttle, based at least in part on determining that the temperature metric satisfies the second threshold, the performance of the memory system by the respective amount indicated by the second performance state.

12. The memory system of claim 11, wherein the one or more controllers are further configured to cause the memory system to:
monitor the temperature metric of the memory system at a third time;
determine, based at least in part on monitoring the temperature metric at the third time, whether the temperature metric satisfies the first threshold, the second threshold, or the third threshold; and
throttle, based at least in part on determining that the temperature metric satisfies the third threshold, the performance of the memory system by the respective amount indicated by the third performance state.

13. The memory system of claim 11, wherein the one or more controllers are further configured to cause the memory system to:
monitor the temperature metric of the memory system at a third time;
determine, based at least in part on monitoring the temperature metric at the third time, whether the temperature metric satisfies a fourth threshold corresponding to the second performance state; and
throttle, based at least in part on determining that the temperature metric satisfies the fourth threshold, the performance of the memory system by the respective amount indicated by the first performance state.

14. The memory system of claim 13, wherein the fourth threshold is lower than the second threshold.

15. The memory system of claim 10, wherein, to throttle the performance of the memory system, the one or more controllers are configured to:
initiate a first timer corresponding to the first performance state;
perform a first set of access operations during a duration of the first timer;
initiate a second timer corresponding to the first performance state based at least in part on an expiration of the first timer; and
refrain from performing a second set of access operation during a duration of the second timer.

16. The memory system of claim 10, wherein, to throttle the performance of the memory system, the one or more controllers are configured to:
update one or more parameters corresponding to a system clock of the memory system.

17. The memory system of claim 10, wherein, to throttle the performance of the memory system, the one or more controllers are configured to:
perform one or more actions that comprise discarding application data, refraining from issuing commands to the one or more memory devices, refraining from performing access commands at the one or more memory devices, or any combination thereof.

18. The memory system of claim 10, wherein the first performance state indicates to throttle the performance of the memory system by at least 30 percent, the second performance state indicates to throttle the performance of the memory system by at least 50 percent, and the third performance state indicates to throttle the performance of the memory system by at least 75 percent.

19. A memory system, comprising:
one or more memory devices; and
processing circuitry coupled with the one or more memory devices and configured to cause the memory system to:
operate the memory system according to a first performance state;
determine, while the memory system operates according to the first performance state, whether a temperature metric of the memory system satisfies a first threshold corresponding to a second performance state;
select, based at least in part on determining that the temperature metric satisfies the first threshold, the second performance state from a plurality of performance states comprising at least the first performance state, the second performance state, and a third performance state; and
operate the memory system according to the second performance state based at least in part on selecting the second performance state.

20. The memory system of claim 19, wherein the processing circuitry is further configured to cause the memory system to:
determine, while the memory system operates according to the second performance state, whether the temperature metric of the memory system satisfies a second threshold corresponding to the third performance state;
select, based at least in part on determining that the temperature metric satisfies the second threshold, the third performance state from the plurality of performance states; and
operate the memory system according to the third performance state based at least in part on selecting the third performance state.

21. The memory system of claim 29, wherein the processing circuitry is further configured to cause the memory system to:
determine, while the memory system operates according to the second performance state, whether the temperature metric of the memory system satisfies a second threshold corresponding to the second performance state;
select, based at least in part on determining that the temperature metric satisfies the second threshold, the first performance state from the plurality of performance states; and
operate the memory system according to the first performance state based at least in part on selecting the third performance state.

22. The memory system of claim 19, wherein operating the memory system according to the second performance state comprises the processing circuitry configured to cause the memory system to:
initiate a first timer corresponding to the second performance state;
perform a first set of access operations during a duration of the first timer;
initiate a second timer corresponding to the second performance state based at least in part on an expiration of the first timer; and
refrain from performing a second set of access operation during a duration of the second timer.
